(19) United States
(12) Patent Application Publication
(10) Pub. No.: US 2022/0140431 A1
(43) Pub. Date: May 5, 2022

(54) Battery Pack Providing Extended Play With Virtual Reality Motion Trackers

(71) Applicant: Matthew Thomas Moon, Montoursville, PA (US)

(72) Inventor: Matthew Thomas Moon, Montoursville, PA (US)

(21) Appl. No.: 17/506,781

(22) Filed: Oct. 21, 2021

Related U.S. Application Data
(60) Provisional application No. 63/108,484, filed on Nov. 2, 2020.

(51) Int. Cl. H01M 50/296; H01M 50/271; H01M 50/207

(52) U.S. Cl. CPC H01M 50/296; H01M 2220/30; H01M 50/207; H01M 50/271

(57) ABSTRACT

An extended life battery pack is provided that directly mates with an electrical power connection on the underside of a virtual reality (VR) motion tracker, eliminating the need for a power cord to be used to connect an external battery the tracker. The extended life battery pack is formed to include a connector that mates with a pre-existing accessory interface on the VR motion tracker and makes a power connection with a defined power pin on the accessory interface. The battery pack is preferably sized to have the same design as the tracker (i.e., circular/cylindrical, similar to a hockey puck).

### CROSS-REFERENCE TO RELATED APPLICATIONS

This application claims priority from U.S. Provisional Application No. 63/108,484, filed Nov. 2, 2020, and herein incorporated by reference.

### TECHNICAL FIELD

The present invention relates to control components used for virtual reality (VR) gaming and, more particularly, to providing extending play through innovative energy sources.

### BACKGROUND OF THE INVENTION

As the complexity level of VR gaming continues to increase, the amount of power required to energize the necessary accessories continues to increase as well. Various arrangements for increasing battery life are looking toward a solution for reducing “downtime” associated with re-charging batteries. “Smart” batteries that monitor the amount of power required in real-time are another solution.

One accessory for VR systems that requires its own power source is a motion tracker. In many games, an individual will wear one or more trackers, where these devices are used to constantly monitor the body movements of the player and incorporate these movements into a figure displayed within a game. “Full-body trackers” have been developed and include a large number of accelerometers, gyroscopes, and other types of motion detectors within a single unit (that may be worn on a belt, strapped on one's wrist, etc.).

Full-body trackers that are now available include an internal battery that needs to be recharged every few hours. One solution that has been suggested is to attach a separate external battery pack to the tracker and use a power cable to attach the battery pack to a charging port (typically, a USB-type of port) on the tracker. However, it is possible for this cable-based connection to come apart during the course of a game, resulting in the same power problems as before.

### SUMMARY OF THE INVENTION

The needs remaining in the art are addressed by the present invention, which relates to an extended life battery pack for a VR motion tracker and, more particularly, to an extended life battery pack that directly mates with an electrical power connection on the underside of the tracker, eliminating the need for a power cord to be used to connect the battery pack to the tracker.

In accordance with the principles of the present invention, an extended life battery pack is formed to include a connector that mates with a pre-existing accessory interface on a motion tracker and makes a power connection with a defined power pin on the accessory interface. The battery pack is preferably sized to have the same design as the tracker (i.e., circular/cylindrical, similar to a hockey puck).

An exemplary embodiment of the present invention comprises a power source for a virtual reality motion tracker comprising a housing, a power connector, and a lid. The housing is used to support one or more batteries, where the power connector is coupled to the batteries and configured to include a pin-based electrical coupling element for mating with a power transfer pin on the virtual reality motion tracker. The lid component is disposed over the housing so as to encase the one or more batteries while providing an aperture that exposes at least the pin-based electrical coupling element of the power connector.

Other and further aspects of the present invention will become apparent during the course of the following discussion and by reference to the accompanying drawings.

### BRIEF DESCRIPTION OF THE DRAWINGS

Referring now to the drawings, where like references represent like parts in several views:

FIG. 1 is an isometric view of a conventional motion tracker in combination with a battery pack formed in accordance with the present invention;

FIG. 2 illustrates a step in the process of attaching the inventive battery pack to the underside of a VR tracker

FIG. 3 is a prior art illustration of a conventional VR tracker attached to a gaming accessory;

FIG. 4 is a diagram of particular features included on a bottom surface of a conventional VR tracker;

FIG. 5 is an exploded view of the housing components used in forming the inventive battery pack of the present invention;

FIG. 6 is a photographic reproduction of an internal view of the inventive battery pack, showing one example layout of the included components;

FIG. 7 includes a set of isometric views of the inventive battery pack, showing both the power pin connector used to provide energy to an attached tracker and an on/off switch used to control the operation of the battery pack;

FIG. 8 is an isometric view of the inventive battery pack as connected to the underside of a conventional VR motion tracker; and

FIG. 9 is a side view of the same arrangement as shown in FIG. 8.

### DETAILED DESCRIPTION

FIG. 1 is an isometric view of a exemplary battery pack 10 formed in accordance with the present invention, as well as a conventional VR motion tracker 1, where as described in detail below battery pack 10 is attached to the underside of motion tracker 1 and electrically connected thereto to provide additional battery power to tracker 1 and extend its playing life. In the view of FIG. 1, battery pack 10 is shown as a separate component, prior to having it be attached to the underside of tracker 1. A power pin 12 is shown as formed on top surface 10S of battery pack 1, where power pin 12 is coupled to batteries housed within battery pack 10. As shown in the embodiment of FIG. 1, battery pack 10 is preferably cylindrical in form (e.g., a hockey puck-type of shape), with its diameter being preferably the same as the diameter of underside of VR tracker 1 (as shown below) for ease of use purposes.

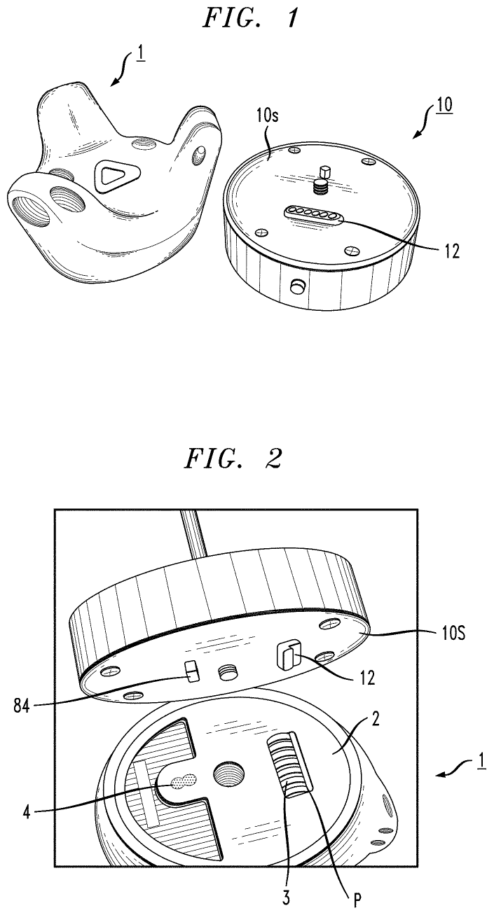

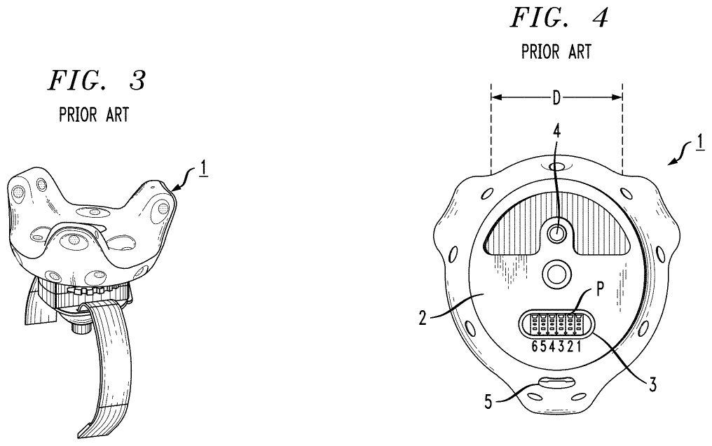

FIG. 2 illustrates a step in the process of attaching battery pack 10 to a bottom surface 2 of VR motion tracker 1. The view of FIG. 2 shows a pin connector 3 that forms part of a conventional motion tracker. In situations where the tracker is mounted on an accessory (such as on a wristband, as shown in FIG. 3), pin connector 3 provides the electrical connection to the accessory and transfers data regarding the movements of the accessory to the tracker (with the tracker thereafter transferring the movement data to the gaming system). the movements in space of the accessory are transmitted to the game via the tracker. While used in conventional arrangements to transmit data regarding movements of an attached accessory, pin connector 3 is used in accordance with the principles of the present invention to couple battery pack 10 to the tracker's internal battery (not shown) and allow for extended play beyond the usual battery life of the tracker itself. That is, the principles of the present invention take advantage of the presence of pin connector 2 to provide power to VR tracker 1 without requiring the attachment of a power cable to a tracker-based power connector 5.

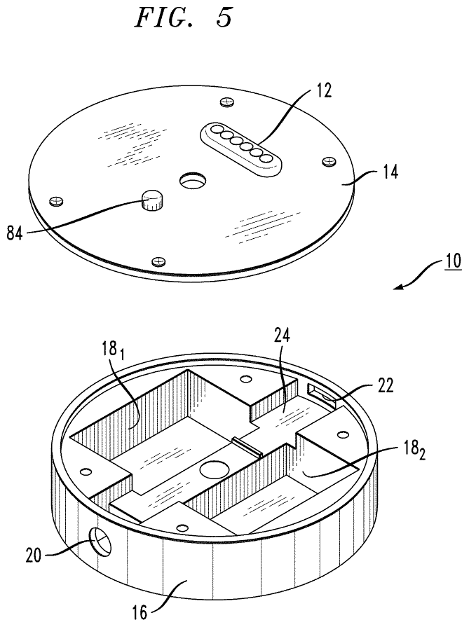

FIG. 4 is a diagram of the particular features included on bottom surface 2 of conventional VR motion tracker 1 and in particular illustrates pin connector 3. In many cases, pin connector 3 comprises a set of spring-loaded conductive pins (also referred to as a “pogo pin”) that provide an electrical connection with a mating component. A defined pin P is the power connection. Returning to the discussion of FIG. 2, a top surface 10S of battery pack 10 is shown as being mated with bottom surface 2 of tracker 1. In accordance with the present invention, battery pack 10 is formed to include alignment features such that power pin 12 of battery pack 10 will align with and also physically contact pin P of pin connector 2, as shown.

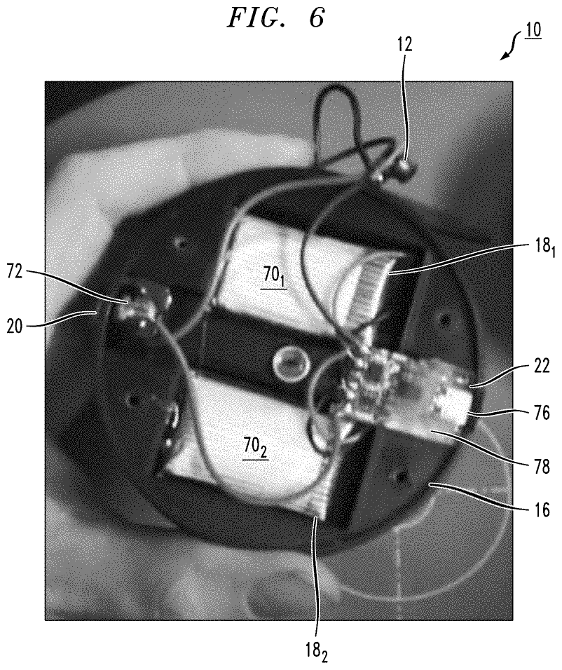

FIG. 5 is a diagrammatic exploded view of the housing components used to form battery pack 10. In particular, FIG. 5 illustrates a base 16 that is formed to include individual regions 18 for holding enclosed batteries. In this particular embodiment, a pair of regions 181, 182 is provided for supporting a pair of batteries. Base 16 also includes a first side aperture 20 used to provide access to an on/off switch (not shown in FIG. 5). Lid component 14 illustrates the location of power connector 12. Additional elements that may be included as part of battery pack 10 include an access 22 to an external USB-based power source. In this case, housing 14 includes a platform 24 for supporting an integrated circuit that is coupled to an external USB adapter and may be used to re-charge the batteries included within battery pack 10.

FIG. 6 is a photographic reproduction of an actual battery pack 10, in this case with lid component 14 removed to better show the individual elements that are included within battery pack 10. In this view, a pair of batteries 701, 702 is shown as positioned within regions 181 and 182, respectively (regions 181, 182 best shown in FIG. 5). An on/off switch 72 (which may be push-button toggle switch or any other type of similar switching device) is shown in FIG. 6 as exposed through aperture 20. On/off switch 72 is connected via included wiring to both batteries 18 and power pin 12.

On/off switch 72 is preferably a “normally open” switch, which prevents the draining of the batteries by needlessly passing their power to pin 12 when not attached to a VR motion tracker. When switch 72 is depressed by a user, the circuit is closed and batteries 70 will be connected to power pin 12. In preferred embodiments, an indicator lamp (e.g., LED) is positioned in proximity to power pin 12 and will light only when batteries 70 are connected to power pin 12.

Also shown in FIG. 6 is a USB adapter 76, which is positioned in opening 22. An internal circuit 78 is shown as coupled to adapter 76 and also connected to batteries 70. Thus, when not being used to power a tracker, battery pack 10 may be re-charged via the included USB adapter. Again, an indicator lamp (LED) may be included and used to show that the batteries are being re-charged. In an exemplary embodiment, the indicator lamp may comprise a pair of LEDs of different color, with a first LED (e.g., yellow) used to signify that charging is taking place and a second LED (e.g., green) used to signify that the batter pack has been fully recharged.

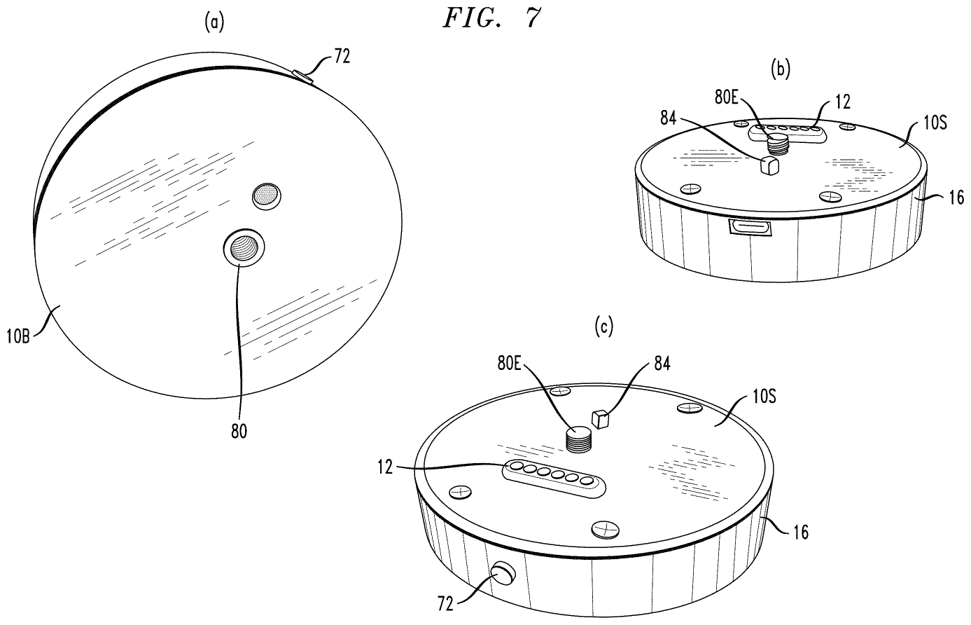

FIG. 7 contains a set of isometric view of battery pack 10, where FIG. 7(a) is a view from the back surface 10B that is visible when battery pack 10 is attached to a VR motion tracker. Evident in this view is a central threaded connector 80 that is used to physically attach battery pack 10 to the tracker. On/off switch 72 is also visible, as is an LED indicator 82. As mentioned above, when on/off switch 72 is activated to provide the battery power to the attached tracker, LED indicator 82 will be lit. FIG. 7(b) is a view of top side 10S of battery pack 10, which shows an extension 80E of threaded connector 80. Power pin 12 is also shown in this view. An alignment feature 84 is shown in this view, where feature 84 may mate with an aperture 4 on VR motion tracker 1 (see FIG. 4) to ensure alignment of power pin 12 to pin P on tracker 1. FIG. 7(c) is another view of top side 10S, where this view also shows the location of on/off switch 72.

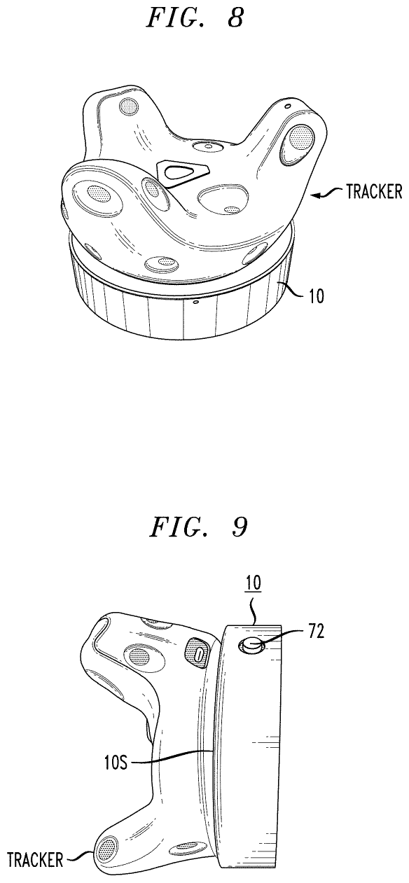

In preferred embodiments, battery pack 10 is formed to have dimensions that correspond to tracker 1, so that once battery pack 10 is attached, the complete arrangement still has the “look and feel” of the original tracker. FIGS. 8 and 9 are isometric views of battery pack 10 as attached to a conventional VR motion tracker. FIG. 8 is an elevated top view of the combination and FIG. 9 is an isometric side view of the same combination. The cylindrical, “hockey puck” configuration of battery pack 10 is shown in both FIGS. 8 and 9 as being a preferred form for easy of player use. The side view of FIG. 9 clearly shows the exposed top side 10S of battery pack 10, as well as on/off switch 72.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications as deemed appropriate.

What is claimed is;:

1. A power source for a virtual reality motion tracker, comprising:
a housing for supporting one or more batteries;
a power connector coupled to the batteries and configured to include a pin-based electrical coupling element for mating with a power transfer pin on the virtual reality motion tracker; and
a lid component disposed over the housing so as to encase the one or more batteries while providing an aperture that exposes at least the pin-based electrical coupling element of the power connector.

2. The power source as defined in claim 1 wherein the housing is configured to support a plurality of batteries.

3. The power source as defined in claim 1 wherein the lid component exhibits a geometry similar to a bottom surface of the virtual reality motion tracker.

4. The power source as defined in claim 1 wherein both the housing and the lid component exhibit geometries similar to a bottom surface of the virtual reality motion tracker.

5. The power source as defined in claim 1 wherein the power source further comprises an on/off switch disposed between the one or more batteries and the power connector.
